(19) United States
(12) Patent Application Publication
(10) Pub. No.: US 2012/0185487 A1
(43) Pub. Date: Jul. 19, 2012

(54) METHOD, DEVICE AND SYSTEM FOR PUBLICATION AND ACQUISITION OF CONTENT

(75) Inventor: Liang Liang, Shenzhen (CN)

(73) Assignee: Huawei Technologies Co., Ltd., Shenzhen (CN)

(21) Appl. No.: 13/432,957

(22) Filed: Mar. 28, 2012

Related U.S. Application Data
(63) Continuation of application No. PCT/CN2010/079864, filed on Dec. 16, 2010.

(30) Foreign Application Priority Data
Dec. 16, 2009 (CN) 200910189003.3

(51) Int. Cl. G06F 17/30

(52) U.S. Cl. 707/747; 707/741; 707/E17.002; 707/E17.005

(57) ABSTRACT

A method for establishing content indexes includes: determining the size of a content space; determining a content address space according to the size of the content space; establishing the mapping relationship from the content space to the content address space and obtaining the content address; monitoring the corresponding content address and accepting the content publication or the content acquisition request of the content mapping space, by the content indexing node.

### CROSS-REFERENCE TO RELATED APPLICATION(S)

This application is a continuation of International Application No. PCT/CN2010/079864, filed on Dec. 16, 2010, which claims priority to Chinese Patent Application No. 200910189003.3, filed on Dec. 16, 2009, both of which are hereby incorporated by reference in their entireties.

### FIELD OF THE APPLICATION

The present application relates to the technical field of data transmission, storage, control, etc., and particularly, to a method for publication and acquisition of contents over network, and a related network device and system.

### BACKGROUND OF THE APPLICATION

With the rapid development of the network technique, functions of a network mainly undergo the following stages:

The first stage: point-to-point connection, e.g., traditional telephone networks, is solved, of which the core technical requirement requires solving connections among a huge number of nodes, i.e., solving the connection from one point to any other point with a minimum cost, and of which the core technique is switching technique; and the main application at the first phage is voice call.

The second stage: after point-to-point voice connection is solved, data communication occurs to solve digital information communication between the hosts of any two points; during this period, switching technique has been a bottom layer support technique; and a high reliability of the communication process is required to ensure that bit errors caused in the transmission of data contents are acceptable to the upper layer service.

As the user's behaviors of consuming digital contents become more and more extensive, the network development enters the third stage; and the network transmits a plenty of digital contents upon the user's request, which raises many new requirements to the network architecture.

At this stage, a huge amount of contents are transmitted in the network, and many of them are the same, e.g., a same digital film or MP3 music is repeatedly transmitted upon the user's request. Since a huge amount of contents are transmitted in the network and the same content is repeatedly transmitted, the demand on bandwidth is very tremendous. In order to save the bandwidth, the prior art proposes an idea of introducing a storage layer (content layer) into the network, and transmitting the contents through the storage layer of the network, so as to reduce the width consumption.

The digital media transmitted in the network require a copyright protection. The network shall acquire what content is transmitted and to whom the content is transmitted. The copyright owner of the digital media shall have a control right to the media consumption.

In order to solve the above problem, the Chinese patent application No. 200610033897.3 proposes to introduce a storage layer (content layer) into the network.

During the introduction of the content layer into the basic network architecture, the following issues are concerned by the present application: how to access a content of the content layer, how to publish a content, and more importantly how to perform a smooth evolution without changing the existing network mechanism.

### SUMMARY OF THE APPLICATION

Embodiments provide a method for publication and acquisition of contents, and a related network device and system, which define how to access a content of the content layer and how to publish a content, and provide a high efficient content storage and publication mechanism.

An embodiment provides a method for establishing content indexes, including:
determining the size of a content space;
determining a content address space according to the size of the content space;
establishing a mapping relationship from the content space to the content address space to establish a content mapping space and obtaining a content address; and
monitoring the content address and accepting a content publication request or a content acquisition request from the content mapping space, by a content indexing node.

An embodiment provides a method for publication of contents, including:
numbering a content or content identification to obtain a content index number;
converging the content index number according to a masking or modularization rule to obtain a content address; and
storing the content index or content to an indexing node where the content address is located.

An embodiment provides a method for publication of contents, including:
hashing a content or content index to obtain a content index number; and
modularizing or masking the content index number.

An embodiment provides a method for publication of contents, including:
hashing a content or content identification to obtain a content index number;
masking the content index number according to a content masking rule to obtain a content address; and
monitoring the content address to obtain a content index or content, or sending a request to the content address to obtain the content index or content, or monitoring the content address to obtain a content node address so as to obtain the content.

An embodiment provides a method for establishing a content layer, including:
joining a network, monitoring a common address space of the content layer, and identifying that there is no content layer node in the network when no action of the content layer indexing node is monitored at the address, by a first indexing node;
periodically broadcasting at the common address space, identifying that the content layer node starts working, and accepting a content layer request message from other node, by the first indexing node index;
joining the network, monitoring the periodical broadcast at the common address space, negotiating with the first indexing node, acquiring the range of indexing space charged by the second indexing node, and determining a content layer channel at which the second indexing node works, by a second indexing node; and
joining the content layer, coordinating the works at the content layer, by a Nth indexing nodej.

An embodiment provides a content network system, including:
a content indexing node configured to manage a content address according to a mapping relationship from a content space to a content address space;
a content node configured to write a content or content index into a content indexing node through a content address channel or a direct connection with the content indexing node; and
a content consumer node configured to obtain the content or content index through the content address channel or the direct connection with the content indexing node.

An embodiment provides an apparatus for publication of contents, including:
a numbering unit configured to number a content or content identification to obtain a content index number;
a content address acquisition unit configured to converge the content index number according to a masking or modularization rule to obtain a content address; and
a storage unit configured to store the content index or content to an indexing node where the content address is located.

An embodiment provides an apparatus for acquisition of contents, including:
a numbering unit configured to obtain a content number from the external or according to a content identification;
a content address acquisition unit configured to obtain a content address from the content number according to a rule; and
a storage unit configured to store the content index or content to an indexing node where the content address is located.

As can be seen from the technical solutions provided by the above embodiments, in a basic network architecture, through a smooth introduction of a content layer, an existing network can be smoothly updated to a content-based network just by increasing indexing nodes and storage nodes, and the network is not modified. By the embodiments, how to access contents in the content layer and how to publish contents are defined, and an efficient mechanism of storing and publication for contents can be provided. Of course, a new content-based network may be constructed based on the disclosed embodiments, so that the network has intelligent functions of content publication, storage, transmission and finding.

### BRIEF DESCRIPTION OF THE DRAWINGS

In order to more clearly describe the technical solutions of the embodiments, the drawings to be used in the description of the embodiments are briefly introduced as follows. Obviously, the following drawings are just some examples, and a person skilled in the art can obtain other drawings from these drawings without paying any creative effort.

FIG. 1 is a schematic diagram of a binary index number space;

FIG. 2 is an index relationship mapping diagram;

FIG. 3 is a schematic diagram of correspondences between a binary index number space and indexing nodes;

FIG. 4 is an index relationship mapping diagram of an introduced content layer;

FIG. 5 is a schematic diagram of an address mask of an indexing node of a content layer;

FIG. 6 is a schematic diagram of division of an address mask of an indexing node of a content layer;

FIG. 7 is a structure diagram of an IPV4 protocol version multicast address space;

FIG. 8 is a schematic diagram of mapping between an IPV4 protocol version multicast address space and an Ethernet protocol multicast address space;

FIG. 9 is a schematic diagram of an IPV6protocol version multicast address space;

FIG. 10 is a schematic diagram of establishment of an indexing node of a content layer;

FIG. 11 is a schematic diagram of correspondences between a content channel, an indexing node and a content node of the content layer;

FIG. 12 is a schematic diagram of a content search in a content layer with an index mechanism;

FIG. 13 is a schematic diagram of a multicast control in a content layer with an index mechanism;

FIG. 14 is a schematic diagram of a path traffic volume control in a content layer with an index mechanism;

FIG. 15 is a schematic table of path traffic volume aggregation during a path traffic volume control in a content layer with an index mechanism;

FIG. 16 is a schematic diagram of a layered networking architecture in a content layer with an index mechanism; and

FIG. 17 is a schematic diagram of establishment of a multicast tree in a content layer with an index mechanism.

### DETAILED DESCRIPTION OF THE EMBODIMENTS

The technical solutions of the embodiments will be clearly and completely described as follows with reference to the drawings. Obviously, the described embodiments are just a part of the embodiments rather than all the embodiments. Based on the embodiments, any other embodiment obtained by a person skilled in the art without paying any creative effort shall fall within the protection scope.

An embodiment provides a method for establishing content indexes, including:
determining the size of a content space;
determining a content address space according to the size of the content space;
establishing mapping relationship from the content space to the content address space and obtaining the content address; and
monitoring a corresponding content address and accepting a content publication request or a content acquisition request of the content mapping space, by the content indexing node.

The content address space is a segment of continuous or discontinuous address space in the IP protocol. Meanwhile, this address space is corresponding to a segment of continuous or discontinuous address space in the bottom layer physical link. An upper layer service or a bottom layer device acquires the content index or directly acquires the content by accessing the address space. This method is also applicable to other protocols.

According to the above method for establishing content indexes, the content indexing node sends a message at the content address through broadcasting or multicasting, to identify the existence of the content indexing node.

The content indexing node identifies the existence of itself for the convenience of other nodes to find the content indexing node. The identification message can also be not sent, while other nodes may request or conform whether the content indexing node is existed by sending a message to the content address.

The content indexing node can simultaneously monitor multiple content addresses, and accept content publication requests or content acquisition requests of multiple content mapping spaces.

For simultaneously monitoring multiple content addresses, the length of the content mask may be extended to obtain multiple content addresses and increase the number of the content addresses to be monitored.

The extension of the mask length increases content addresses; the content indexing node is divided, and the generated new content layer indexing nodes work at the added content addresses to be monitored.

The content indexes are obtained from the contents or the content identifications through an algorithm such as a consistent hash algorithm or other algorithms.

The content indexes may be numbered in segments, and different segments are corresponding to different attributes to identify services or make a service aggregation.

The content indexes may be obtained by hashing the host IP addresses or the host MAC addresses, wherein indexes of the host IP addresses or the host MAC addresses are used to find or register hosts.

The content indexes may be obtained by hashing source address and destination address of the link in segments, and be used to find a path or optimize traffic volume.

An embodiment provides a method for publication of contents, including:
numbering a content or content identification to obtain a content index number;
converging the content index number according to a rule (masking or modularization) to obtain a content address; and
storing the content index or content to an indexing node where the content address is located.

The above method obtains the content index number by hashing the content or the content index.

The content address is obtained by modularizing or masking the content index number.

In the method, the rule is obtained through a common address. The rule may be a masking rule, a modularization rule, a dynamic coding rule, information such as length of a mask, the number of the indexing nodes, addresses of the indexing nodes, etc. The rule is broadcast or multicast in a common address channel.

In case that the rule is a dynamic rule, the content address where the indexing node works are obtained by dynamically extending the mask length to dynamically monitor the content addresses of masks of different lengths.

The common address space is merely composed of content layer addresses of all bits being 0 or 1, other appointed content layer addresses, broadcast or multicast messages of other addresses, or other messages.

An embodiment provides a method for acquisition of contents, including:
hashing a content or a content identification to obtain a content index number;
masking the content index number according to a content masking rule to obtain a content address;
monitoring the content address to obtain a content index or content;
or sending a request to the content address to obtain the content index or content, or monitoring the content address to obtain a content node address so as to obtain the content.

An embodiment provides a method for establishing a content layer, including:
step 100: after joining the network, indexing node 1 (X1) monitors the common address space of the content layer, and identifies that there is no content layer node in the network when no action of the content layer indexing node is monitored at the address;
step 200: indexing node 1 (X1) periodically broadcasts at the common address space, identifies that the content layer node starts working, and accepts a content layer request message from other node such as a terminal, a router or a switch;
step 300: after joining the network, indexing node 2(X2) monitors the periodical broadcast at the common address space, negotiates with indexing node 1 (X1), acquires the range of indexing space charged by indexing node 2(X2), and determines a content layer channel at which indexing node 2(X2) works;
repeating step 300, adding indexing node N to the content layer to coordinate works at the content layer.

An embodiment provides a content network system, including: a content indexing node, a content generation and publication node, and a content consumer node.

The content indexing node is configured to manage content addresses according to the mapping relationship from the content space to the content address space.

The content generation and publication node is configured to write a content or content index into the content indexing node through a content address channel or a direct connection with the content indexing node.

The content consumer node is configured to obtain the content or content index through the content address channel or the direct connection with the content indexing node.

The above network further includes a content storage node. The network perceives the strength and tendency of the content consumption, increases the number and contents of the content indexing nodes, and publish at the content indexing nodes.

The content indexing nodes and the content storage nodes constitute a content layer in the network eight-layer model (the content layer is added in relation to the traditional seven-layer model) protocol, for providing content publication, storage and duplicate diffusion for the upper layer service.

The content indexing node sends a message at the content address through broadcasting or multicasting, to identify the existence of the content indexing node.

The content indexing node monitors multiple content addresses, and accepts a content publication request or a content acquisition request from multiple content mapping spaces.

An embodiment provides a device for publication of contents, including:
a numbering unit configured to number a content or content identification to obtain a content index number;
a content address acquisition unit configured to converge the content index number according to a rule (masking or modularization) to obtain a content address; and
a storage unit configured to store the content index or content to an indexing node where the content address is located.

The numbering unit is further configured to hash the content or content index to obtain the content index number; and modularize or mask the content index number to obtain the content address.

An embodiment provides a device for acquisition of contents, including:
a numbering unit configured to obtain a content number from the external or according to a content identification;
a content address acquisition unit configured to obtain a content address from the content number according to a rule; and
a storage unit configured to store the content index or content to an indexing node where the content address is located.

The content acquisition may obtain the content index or content by monitoring the content address, or sending a request to the content address.

Alternatively, the address of the content indexing node or content node where the content index is located may be obtained by monitoring the content address, so as to obtain the content index or content by sending a request to the address.

The content layer is introduced into the network for two tasks: storage of contents, and publication and transmission of contents.

The operation on the content layer shall meet several requirements, for example:
1. the data has one or more publication sources or attributions, which may be centers that store a huge amount of data;
2. the data can be automatically transmitted to the user upon the network user's request;
3. an appropriate data duplicate can be automatically generated to expand the service capability for the user;
4. service levels can be distinguished, and services are provided to the user according to the data authority, user authority, etc.;
5. data integrity can be automatically monitored, distorted data can be automatically discarded; when the data duplicate is generated, the data integrity is automatically monitored to prevent any defective data duplicate;
6. the data is stored and cached in respective devices rather than being bound to any specific device, and the data search is irrelevant to the device search;
7. the system overhead caused by the data duplicate shall be reduced, and the existing data duplicate is extracted so far as possible during the data consumption;
8. the data for data search and location shall be improved, and the system message overhead for data search shall be reduced.

Through the above analysis, it can be seen that the network nodes shall meet the following features for introducing the data layer into the network:
feature 1: network elements have data storage or caching capability;
feature 2: network elements can respond to a data inquiry; and
feature 3: network elements have data inquiry capability.

The network elements simultaneously have capabilities of routing or path exchanging and data storage, and there have been quite a few solutions. For features 2 and 3, they actually need to solve the data inquiry.

The technical problem to be solved for storing/extracting data into/from the network is data naming and routing.

In order to quickly find data in the network while reducing data inquiries and message publication overhead, it is necessary to uniformly code the data stored (stored for a long time) and cached (stored for a short time) in the network, while establishing an index mechanism to reduce the data inquiries and message publication system overhead.

Due to data diversity, uniform data naming shall be appointed based on a certain standard. With respect to the network, it is necessary to adopt the data of uniform coding length or uniform specification to meet the network hardware quick processing. Of course, with the increase of data amount, the coding length may be varied.

When an index system is established in a network such as an intra-network, metropolitan area network or local area network, a convenient access mechanism shall be provided for upper layer service nodes, bottom layer routing and switching nodes.

By establishing the index mechanism in the network, the indexing space may be matched with the host space. Since the indexing space is huge, multiple devices (e.g., routers, switches or specific index service nodes) are required to coordinate to complete the service of the whole indexing space.

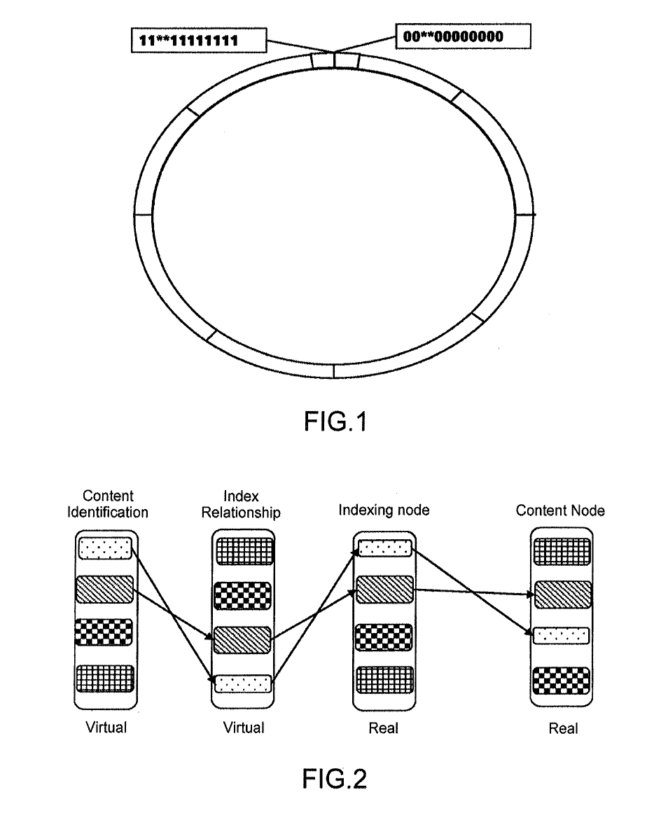

FIG. 1 is a schematic diagram of an index coding space, and when the coding length is a 128-bit binary length, it ranges from 128-bit 0 to 128-bit 1.

Any character may be uniformly mapped to the index coding space in a certain algorithm such as consistent hash algorithm, based on mathematical principles.

The basic principle for the content search with index is to map the content name to an indexing space, the index shall be stored in a concrete host (indexing node), and the indexing space stores the correspondence between the index and the content host address stored in the content.

It can be seen that the content identification and the index relationship are logic concepts and are logically real. But they are not corresponding to the concrete physical host, in other words, they are corresponding to any physical host.

The index storage and content storage are related to the concrete physical storage. When being stored in the concrete physical device having an IP or MAC address, the content or index may be accessed.

The content layer is introduced into the network hierarchy. In the long term, all network nodes will be concerned in the content publication, search, finding, etc. The publication and finding of the host address of the index service node and the host address of the content node are very critical.

The content layer is introduced into the network hierarchy. The protocols of other hierarchies may be various known or unknown protocols. The content layer may be introduced based on the Ethernet or the IP protocol.

FIG. 2 is an index relationship mapping diagram.

The content identification is generally a character string of unequal length. It is characterized in being “virtual” and having infinite possibilities.

The index relationship includes name serial numbers, and has infinite possibilities due to the unequal length of the content identification. For the convenience of search and storage, the name of the content identification shall be numbered. There are various numbering manners, such as allocating the number, obtaining the number by hashing the content identification, etc. The name numbers usually have the same length or fixed lengths. The index relationship further includes a content storage position, and when the position is changed, the index shall be updated immediately.

When a content is generated, it has a name, and correspondingly there is a name number. The number of name shall be concretely existed in a concrete device. The concrete content is existed in a concrete time, and occupies a concrete physical device. The node storing the concrete content is called as content node, and it is characterized in being “real”.

In case that a content is extracted, the stored content node position of the content shall be acquired. Therefore, a method is required to store or calculate the content storage position. Since the content node of the concrete content storage node is changeable, usually the correspondence is stored with the index. The node storing the index is called as indexing node.

If the content and the index are stored in the same node, the content will be found once the indexing node is found. If they are not stored together, the address of the content node shall be found by acquiring the index relationship stored in the indexing node.

In the ISO seven-layer protocol or other protocol stack, the content layer is introduced into the network, and the network may have a memory capability and certain intelligence.

In the index system, the indexing nodes shall be stored in a concrete physical device, and responsible for the indexes of an indexing space, respectively.

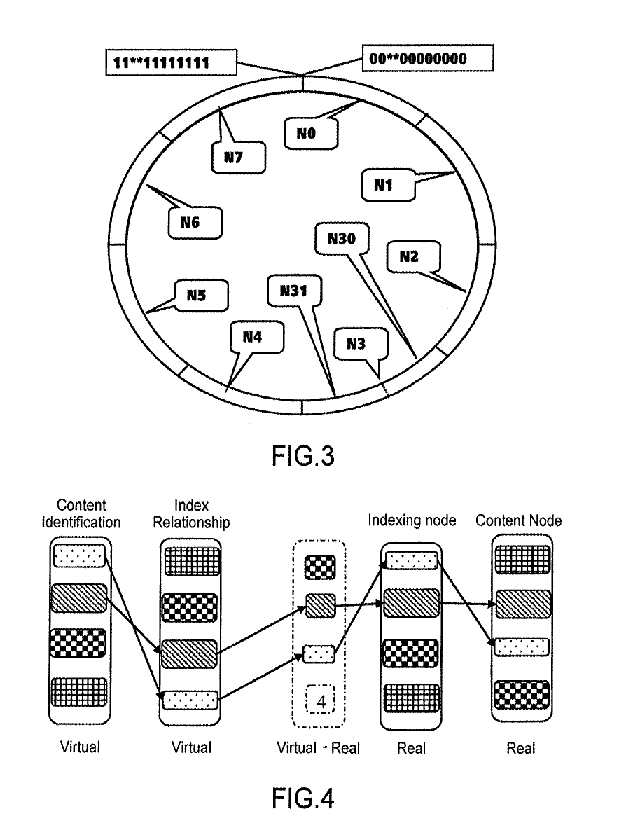

As illustrated in FIG. 3, it is assumed that there are eight nodes responsible for the management of an indexing space in a subnet, wherein N0-N7 are responsible for storage, inquiry and registration of index relationships in the same spatial range.

Other nodes cannot access these index relationships unless acquiring addresses of nodes N0-N7, or enabling nodes N0-N7 to receive relevant information.

An indexing space is very large, and relevant messages are frequently sent, thus it is impossible for N0-N7 to receive all the messages, i.e., N0-N7 will unlikely use the same address space.

Meanwhile, with the increase of the index relationships, many index service nodes shall be divided, and other or new nodes are required to process relevant messages. For example, index service node N3 is divided into two nodes N30 and N31, and the following issues are very critical: how to migrate the original information from node N3 to N30 and N31 respectively, and how can other nodes in the network find N30 and N31.

During the operation, any host may be shutdown or busy, and the index service nodes shall coordinate with each other. For example, node 5 and node 3 are in a ring correspondence (3+5=8), i.e., they mutually store the data of the other party, and when node 3 cannot work, node 5 automatically takes over the work of node 3.

The above characteristics all have a problem, i.e., how to find and maintain the correspondence between the “virtual” index relationship and the “real” index storage as illustrated in FIG. 2.

In order to solve this problem, a virtual-to-real conversion mechanism shall be available. That is to say, a relationship simultaneously having “virtual” and “real” characteristics is required to combine the “virtual” and “real” relationships.

As illustrated in FIG. 4, a data space consistent with the indexing space is set, and it has a convergent characteristic with the convergence range directly mapped to concrete host addressing address space. As illustrated in FIG. 4, among the “virtual” to “real” mapping data spaces, each of data spaces 0-4 is equally divided into 4 spaces directly corresponding to 4 host spaces.

Specifically, in the IP protocol, Ethernet protocol or other protocol, a segment of continuous address space is allocated. The address space is mapped to the data indexing space and is a virtual address space accessible by a host (or server, router, switch, etc.) in other address space. The host (or server, router, switch, etc.) works in this specific address space is not bound thereto.

With the virtual content address space, the indexing node is no longer limited by the concrete physical machine. Any device works in the virtual content address space can complete the indexing work by responding to the message in the address space. But if all the nodes working in the content address space respond to the message in the address space, a large system overhead will be caused. Thus a certain convergence shall be made to enable a concrete node to manage the indexes of respective sections.

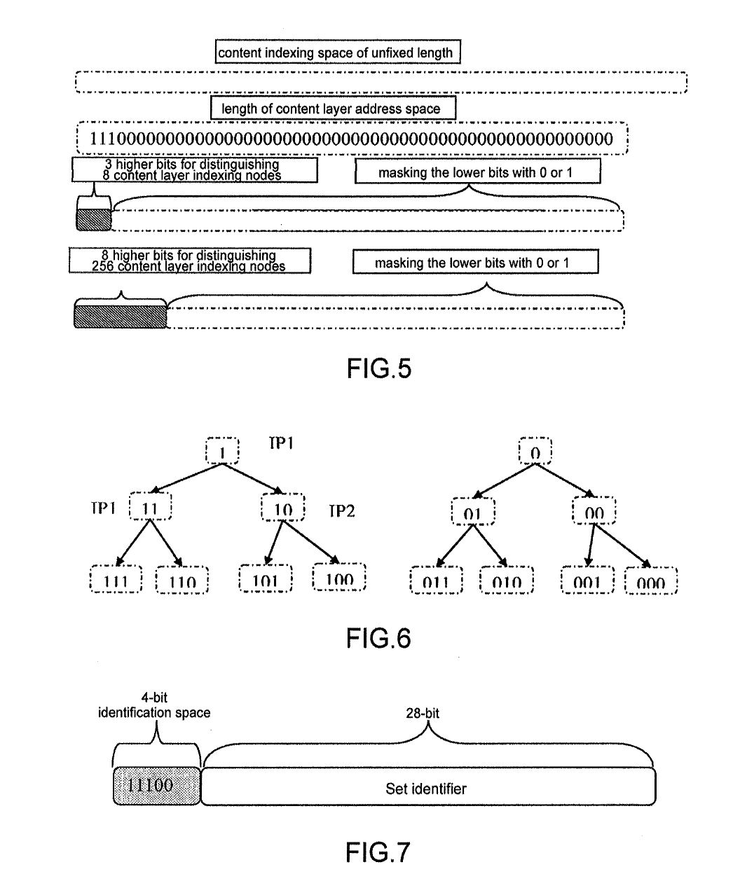

As illustrated in FIG. 5, the length of the indexing space is not limited, and it is assumed as 128 bits. The content indexing space is masked with the three higher bits 111, and a NOT operation is then carried out in bits to obtain an address space. If the host address space is identified with bits 1 and 0, the identified host addresses obtained by masking with the three higher bits shall be:
0001111111, 0011111111
0101111111, 0111111111
1001111111, 1011111111
1101111111, 1111111111

The eight address spaces are corresponding to the indexes of eight spaces 0-0001111111 . . . 11 (the number of 1 is 125), respectively, which can be acquired at the eight host address spaces.

With the increase of the index contents, the number of bits for the mask shall be expanded for the added amount of index service nodes. For example, 8 bits may be adopted. The 8-bit mask is corresponding to 256 host addresses, and each of the original eight address-spaces is divided into 32 address spaces. The contents in these address spaces form content slices, and one host stores one or more slices.

The number of the address spaces to be monitored is the number of the slices stored in each host, and index message requests in these address spaces are received.

The address space division is very convenient for the index migration. As illustrated in FIG. 6, when the mask length is 1, two hosts are distinguished, and when the mask length is 2, four hosts are distinguished. The addresses of the four hosts are evolved from the addresses of the original hosts. In case that host 11 is the original host 1 (IP1) and host 10 is a new host (IP2), only half data needs to be migrated to the new host 10.

As the address space of the content layer is different from the actual host address, the data migration between the hosts 10 and 11 may be completely smooth. IP1 and IP2 can simultaneously work in the address channel of host 10 during the data migration. After the data migration is completed, IP1 exits the service of the address channel of host 10.

As the address space of the content layer is different from the actual host address, multiple hosts may work in the same address space. This method can conveniently realize multiple data backups and the work load allocation.

If host 0 has a very strong processing capability, the data migration is not made in case that the mask length is extended from 1 to 2, and only information in the address fields 01 and 00 needs to be processed.

The indefinite length mask or dynamic mask may also be used. After the index number is acquired, the masking is performed from the highest bit. The content index channel is stepwise scanned with 1-bit, 2-bit and 3-bit, so to monitor the index service node and find the node where the index is located.

Similarly, when the indexes at a node are increased to a certain amount, the mask length can be extended automatically, and some index service contents charged thereby are allocated to other nodes.

In principle, the consistent hash algorithm shall be strictly performed. In the hash space, the data is distributed uniformly, but in order for service aggregation, the specific hash mask may be allocated with specific service, thus the space may be non-uniform. Different dynamic masks may be used for different services or different types of data, and the length is also dynamically changed. The dynamic information can be broadcast or coordinated in the common content address channel.

The content address spaces shall be allocated independently, and shall have the following features:

1. The address space is continuous for the convenience of content host division.

When there is no continuous address space, the correspondence between the indexing space and the address shall be notified to all nodes, which increases the management overhead and cannot be achieved automatically based on a rule.

2. The address space has broadcasting or multicasting characteristic, and the message sent from a host in the network can be received by all other hosts.

As the index inquiry may be very frequent, e.g., some information is simultaneously required by many devices in the network, the information may be quickly publicized by broadcasting or multicasting.

The information not required by so many devices may be publicized or inquired through unicasting, so as to reduce the consumption of the system bandwidth.

3. The address space is irrelevant to the concrete host, and the host works therein may join in or exit at any time.

4. The masking by bit is supported.

The function of masking is to quickly make an automatic division of the indexing space, and it is necessary for the network with its scale dynamically changed.

Currently in the IP address space, the multicast protocol in the Ethernet address space has some of the above features.

FIG. 7 illustrates the multicast address space in the IPV4 protocol, and it has the characteristics of the content address space, but certain processing shall be performed for the content storage.

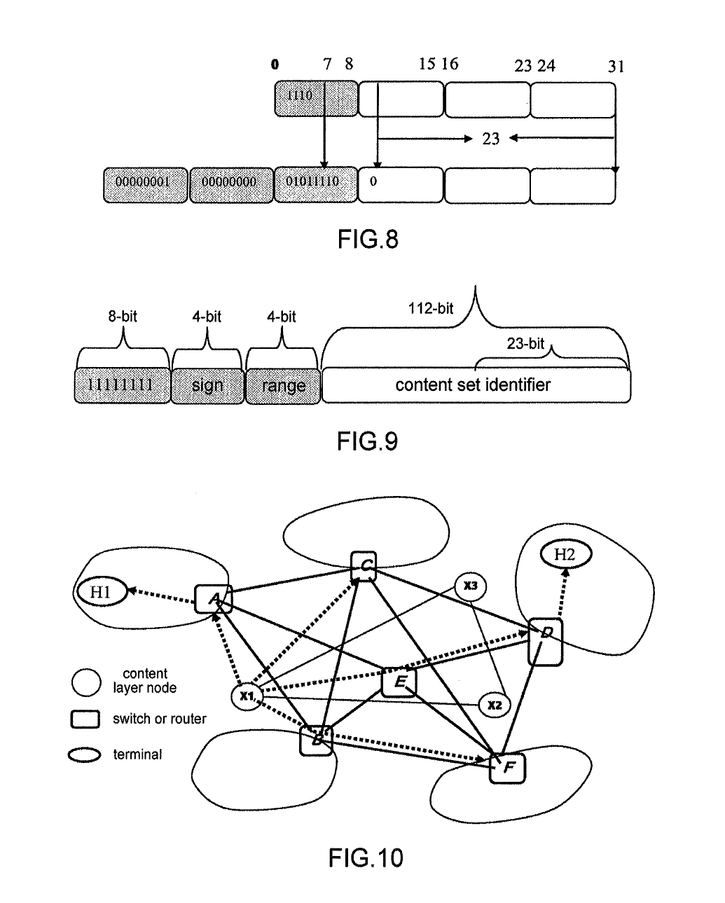

FIG. 8 illustrates a mapping from a multicast address space to an Ethernet address space in the IPV6 protocol, wherein the 23-bit IP address is mapped to the 23-bit Ethernet multicast address space.

For the IPV6 protocol, an address space continuously mapped to the Ethernet shall also be found or specified.

As illustrated in FIG. 9, in the IPV6 multicast address space, a 23-bit address space is allocated to be mapped to the content layer space of the Ethernet.

In case that the IP protocol runs in the Ethernet, and the 23-bit Ethernet message multicast space is used as the content layer address space, in the IPV6 protocol the address space shall be aligned with the Ethernet multicast space in the address, so as to utilize the multicast capability of the Ethernet layer switch.

In order to distinguish the multicast space and content layer space, 23 of the 23-bit multicast space may be used to divide the multicast space and address layer space.

Alternatively, the content layer may be distinguished by VLAN, i.e., a VLAN number may be used to distinguish the content layer address coding and the multicast address coding.

As illustrated in FIG. 10, in the network including switches or routers, the terminal works at the port of each switch, while the traditional network has no content layer capability or content layer node.

After joining the network, a node (e.g., X1) supporting the index content layer acquires IP and MAC addresses of the host based on the traditional mechanism.

Step 100: after joining the network, node X1 monitors the common address space of the content layer, e.g., a content layer address merely composed of 1 or 0 (11111111***11111111, or 00000000***00000000); if no action of the content layer node is monitored at the address, identifies that there is no content layer node in the network.

Step 200: node X1 periodically broadcasts at the common address space (e.g., in a cycle of 0.1 s), identifies that the content layer node starts working, and accepts a content layer request message from other node such as a terminal, a router or a switch.

Step 300: after joining the network, the second content layer node X2 monitors the periodical broadcast at the common address space and the periodic broadcast from X1 will be received; node X2 negotiates with node X1, and acquires the range of indexing space charged by node X2.

The subsequent nodes repeat step 300, and the nodes added to the content layer construct the content index layer, and coordinate the content works.

The common address space information can provide the following information:

1. Mask Length

After obtaining the mask length, the terminal or content layer host can acquire the number of the address channels of the content layer in the range of the network, so as to obtain the rule for content layer search.

The mask length also may be appointed and not broadcast. As the host scale of each sub-network is expectable, the periodic broadcast may not concern the mask length when the mask length is appointed.

2. IP Address and MAC Address of Node X1

Through the common address space of the content layer, other devices may obtain the IP address and MAC address of the host running in the common address space of the content layer, and negotiate other message with node X1 via a TCP connection, thereby purifying the message of the common address space of the content layer.

3. Version Number of the Content Layer Protocol

The version number indicates the version of the content layer protocol, for the convenience of connections between respective nodes.

4. Other Contents Such as Network Scale or Index Information Broadcast

The current network bandwidth is greatly improved in relation to the past, especially inside the LAN, the index information is very small compared with the media information transmitted in the network. Thus it is better to directly broadcast the index information periodically (at the content layer multicast address) than waiting the inquiry of the index information at the index service node by respective nodes.

The system mask length is M, and the number of the index information multicast addresses is 2^{M}. When the system only has a few hosts and a little index information, multiple index information multicast channels may be operated by one host.

The broadcast frequency of the index information is variable, and when the varied information is quickly broadcast, the multicast frequency is stepwise decreased for the stable data index information, so as to reduce the system overhead.

For the terminal (information consumer node), relevant information shall be obtained for a processing. Obviously, the concerned section of the index information is changed at different moments since the upper layer services or periods run by the information consumer nodes are different. Thus the information consumer nodes only monitor limited content layer multicast addresses, and overhead of the processing of the information layer index caused by each information consumer node is very small. In addition, the information consumer node may cache the interested index information to be used by the upper layer service.

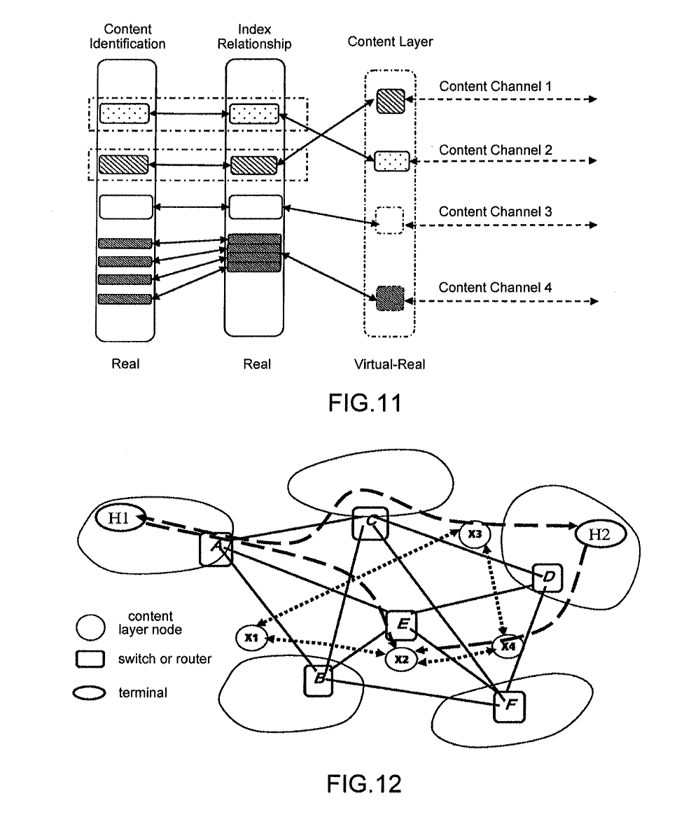

As illustrated in FIG. 11, in a network the mask length of the content layer is 2, and 4 content layer channels are established. The information production node and the information consumer node can obtain the addresses of the index machine of the content layer from content channels 1-4, respectively. The address of the content machine can be obtained through the indexing, and when the content machine is found, the content may be stored therein or obtained therefrom.

In the actual arrangement, the index machine and the content machine may be integrated with each other, such as channel 1 or channel 2, or separated from each other such as channel 3.

Alternatively one index machine may be corresponding to multiple content machines, such as channel 4.

When contents are cached in the network, they can be directly cached to different index-content integrated machines based on the content names. The hot content is required by many users and can be distributed to different machines. The index shall be registered at the index service node for uniformly sharing the load.

When certain contents are known as hot and many caches are required, a fixed prefix may be added during content naming to identify the content as a hot content. For example, when the prefix is 4, it is automatically mapped to content channel 4 during the content index registration.

By adding the fixed prefix to the content, different types of data and services can be distinguished, and the data or services of the same type are continued to be converged to the specific index service machine.

As illustrated in FIG. 12, x1-x4 construct content layers to provide the content layer services, and periodically identify their existences at respective content layers.

The terminal nodes H1 and H2 are the content information generator and the information consumer.

H1 has a piece of information M to be published to the network, and the name of information M is www.M.H1.COM.

H1 generates K21 based on information M, and makes K21 be corresponding to content channel 2.

H1 obtains the host address of X2 by monitoring content channel 2, and stores index information <K21, H1> into X2.

Alternatively, H1 directly sends index information <K21, H1> in content channel 2.

H2 shall obtain the name www.M.H1.COM of information M.

H2 generates K21 based on information M, and makes K21 be corresponding to content channel 2.

H2 obtains the host address of X2 by monitoring content channel 2, acquires index information <K21, H1> from X2, and finds that information M is located in H1.

Alternatively, H2 directly monitors the message in content channel 2 to obtain index information <K21, H1>.

Obviously, by uniformly storing the index information into nodes X1-X4, overheads of the information production node and the information consumer node are reduced.

Nodes X1-X4 can periodically broadcast the obtained index information, and H2 receives the periodical multicast from node X2 without inquiring node X2.

The periodical broadcast is suitable to some instant messages and most services. For example, the VOIP processing is as follows: for the instant information such as a multi-party conference, one voice packet or video packet shall be transmitted to multiple users, and the users periodically obtain joining or exiting information.

There are multiple methods for generating K21, and in order for service aggregation, it is suggested to hash in segments.

For Example:

K21=hash (com)+hash (h1)+hash (M), in which the respective portions are characters having the same length, so that the contents about H1 are aggregated to the same content channel.

After the content layer is added to the network, the content index channel is available and can be applied to many other services and the system management.

Multicast Management and Optimization

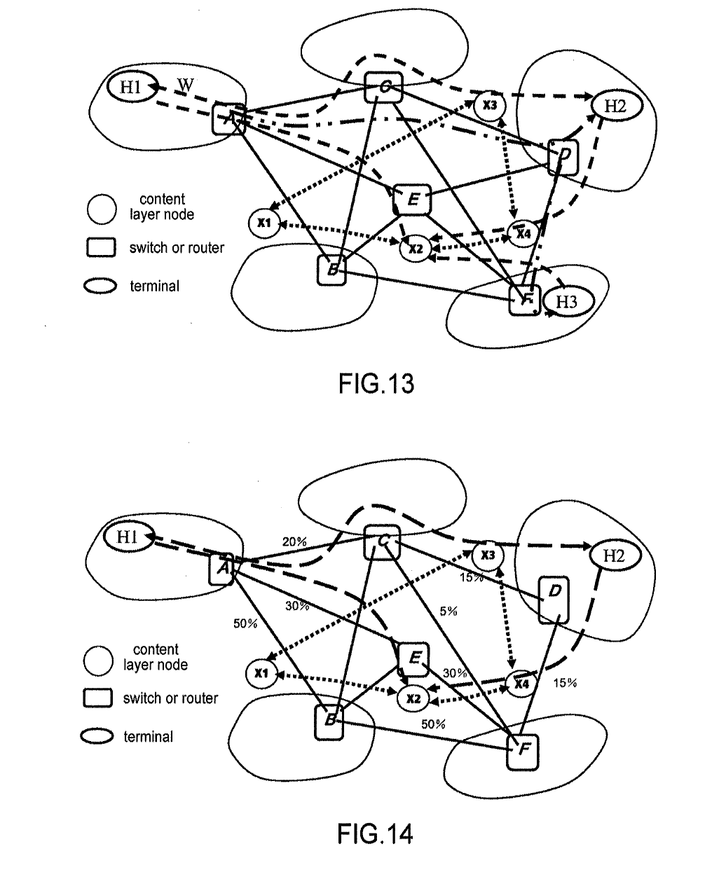

As illustrated in FIG. 13, the host H1 has a multicast source (w) and registers the multicast name at X2; X2 registers the multicast information as a special content item, and solves the confliction between the multicast space and the content channel; and when a confliction occurs, H1 shall be suppressed or notified of a multicast number not causing a confliction.

For the multicast content, in case that H1 adopts the numbering manner appointed by the content layer to avoid the serial number of the content channel, the confliction will also not be caused.

H2-H3 shall join in w, find x2 based on its rule, obtain the multicast number of w and join in the multicast reception.

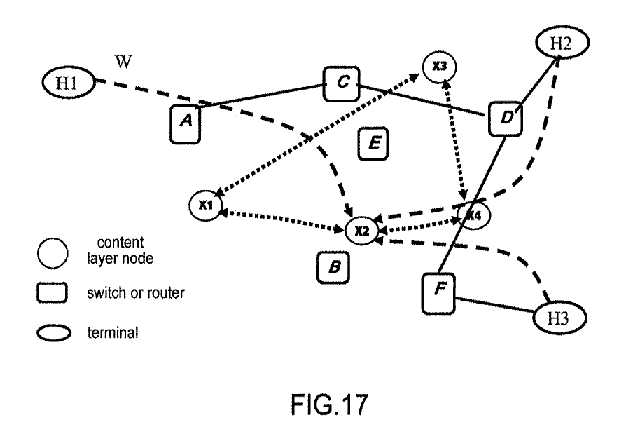

FIG. 17 illustrates a process of establishing a multicast tree. H2 requests joining in the multicast source (w), and after necessary authentication, X2 manages the router or switch A, C, D to establish multicast channel A-C-D.

H3 requests joining in the multicast source (w), and after necessary authentication, X2 analyzes the existing multicast tree and establishes D-F multicast path.

The removal of the multicast tree is also managed by X2.

The content layer is used for managing the multicast tree establishment, and the multicast channel allocation and recovery, so as to automatically apportion the huge management and computation task to the content layer nodes. With this solution, the establishment and maintenance of a large number of multicast trees are supported.

After being added with the content layer, the network can perform many works about internal management and optimization by using the content layer channel. For example, after finding that H1 joins in the network, the host hashes the MAC address, then finds X2, registers the port information of A to X2, or obtains the host IP address allocation at X2 through DHCP.

H2 hopes to communicate with H1 and acquire the IP address of H1, without the MAC address and port routing information of H1, which can also be obtained via X2.

On the other hand, when the content layer is available, and particularly, the switch and router also supports the content layer protocol, various information that shall be found through broadcast flooding in the past can be publicized and found by being registered to corresponding content index service node.

The application layer is not so related to the relationship between the concrete machine and content, and only the required content needs to be acquired.

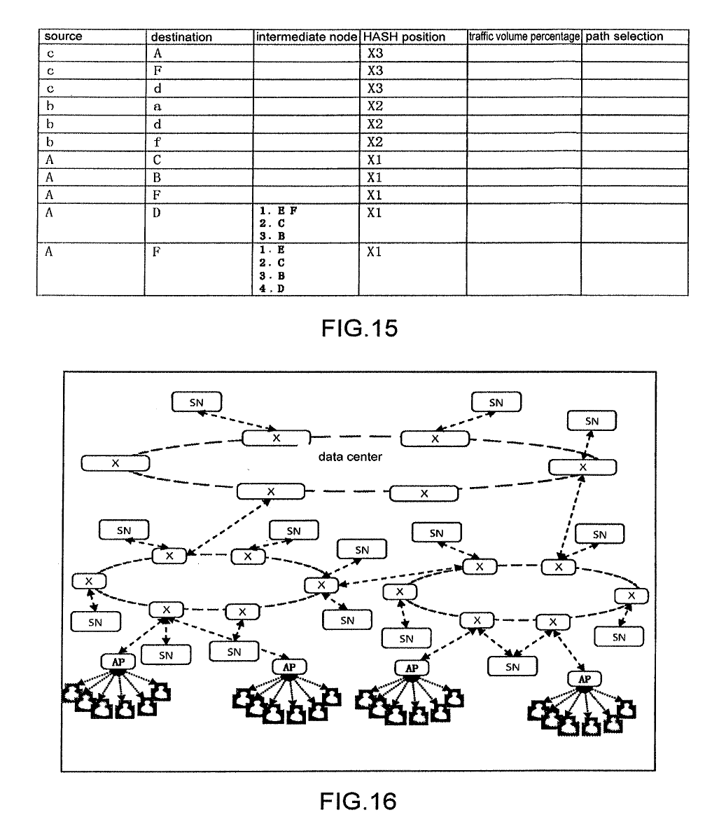

The content layer is used to path selection and planning. FIG. 15 is part of network topology of FIG. 14, and each path is registered to corresponding index service node of the content layer, and the traffic volume of the link is periodically publicized in corresponding content layer.

With respect to traffic volumes A to F, X1 may instruct, according to the traffic volumes of paths A-E-F, A-C-F, A-B-F, A-C-D-F, the router or switch to adjust the dynamic allocation of the traffic volumes of the paths.

As illustrated in FIG. 14, at port A, the allocation proportions of the traffic volumes are 50%, 30% and 20%, and at port C, the allocation proportions of the traffic volumes are 5% and 15%.

When the content layer is used for path selection and planning, the computations of respective paths may be distributed to different index service nodes of the content layer based on the coding rules. Meanwhile, real time traffic information of corresponding link can be acquired through the multicast path. The mechanism automatically distributes the huge distributed computing tasks to different computing points, and also exerts the function of aggregation, i.e., the processing in one link being automatically aggregated to a computing point.

When being used in the path planning, the content layer mechanism will cause a large basic traffic overhead, thereby influencing the content layer index at certain extent.

A specific VLAN may be planned to isolate the path optimization mechanism, and limit the traffic between the route management node and the route optimization node.

FIG. 16 is a network including the content layer, and each of the different sub-networks includes its content layer space. If the TTL value of a message of the content layer is 1, the message is inside the sub-network. If no content is found in the sub-network, TTL will be increased for a search between the sub-networks.

Alternatively, each sub-network may include a proxy node processing information inquiry or information injected from other sub-network, or acting for information inquiry or information injected from the local node to other sub-network.

The application layer P2P networking or a content layer based on the IP protocol may be adopted between the proxy nodes.

When being publicized, each data may include two parameters:

1. The Address or Domain Name of the Data Producer

After being produced by an enterprise, a website or a person, the data is publicized and transmitted in the network, and other sub-networks can cache the whole data to be used by the data consumer. When the data consumption amount increases, duplicate and index diffusions can be carried out.

With the decrease of the usage by the consumer, the duplicate gradually disappears while the index may be reserved for a long time. The data producer can be found according to the index, so as to acquire the data.

2. Data Attributive Address or Domain Name

It is a high cost for either the person or the enterprise to main the data reliability. Some enterprises or governments provide a data center, and after the data is publicized by the producer and transmitted to the network, the network transmits the data to the attributive center according to the attributive address or domain name.

As illustrated in FIG. 16, when the user is allowed to directly access the content layer node in the metropolitan area network or other application environment, many network problems may be caused, for example, the user maliciously blocks the content layer channel such that the content layer cannot work normally. Thus it is necessary to isolate the content layer, wherein the AP proxy user accesses the content layer, or injects/extracts data into/from the content layer.

The units and algorithm steps in respective examples of the embodiments disclosed herein can be implemented by electronic hardware, computer software or a combination thereof. In order to clearly describe the interchangeability between the hardware and the software, compositions and steps of the examples have been generally described in functions as above. Whether those functions are performed by hardware or software depends on the specific application and designed constraint condition of the technical solution. For each specific application, a person skilled in the art may implement the described functions in different methods, and the implementation shall not be regarded as going beyond the scope.

The method or algorithm steps described in the embodiments disclosed herein can be implemented by hardware, software unit executable by the processor, or a combination thereof. The software unit may be embedded in RAM, internal memory, ROM, EPROM, EEPROM, register, hard disk, mobile disk, CD-ROM or a storage medium of any other form.

The embodiments described above are merely exemplary. It is understood that various modification may be made to the embodiments by a person skilled in the art. Such modifications are considered to fall within the scope of protection of the claims.

What is claimed is:

1. A method for establishing content indexes, comprising:
determining a size of a content space;
determining a content address space according to the size of the content space;
establishing a mapping relationship from the content space to the content address space to establish a content mapping space and to obtain a content address;
monitoring the content address; and
accepting a content publication request or a content acquisition request from the content mapping space, by a content indexing node.

2. The method according to claim 1, further comprising:
sending, by the content indexing node, at the content address, a message to identify an existence of the content indexing node.

3. The method according to claim 1, further comprising:
monitoring at least one content address and accepting the content publication request or the content acquisition request from at least one content mapping space, by the content indexing node.

4. A method for publication of contents, comprising:
numbering a content or content identification to obtain a content index number;
converging the content index number according to a masking or modularization rule to obtain a content address; and
storing the content index or content to an indexing node where the content address is located.

5. A method for publication of contents, comprising:
hashing a content or content index to obtain a content index number;
modularizing or masking the content index number.

6. A method for acquisition of contents, comprising:
hashing a content or content identification to obtain a content index number;
masking the content index number according to a content masking rule to obtain a content address; and
monitoring the content address to obtain a content index or content, or sending a request to the content address to obtain the content index or content, or monitoring the content address to obtain a content node address to obtain the content.

7. A method for establishing a content layer, comprising:
joining a network;
monitoring a common address space of the content layer;
determining, by a first indexing node, that there is no content layer node in the network when no action of a content layer indexing node is monitored at the common address space;
periodically broadcasting at the common address spacethat the content layer node has started to work, and accepting a content layer request message from other nodes, by the first indexing node index;
joining the network;
monitoring the periodical broadcast at the common address space;
negotiating with the first indexing node;
acquiring a range of indexing space charged by the second indexing node;
determining, by a second indexing node, a content layer channel at which the second indexing node works;
joining the content layer; and
coordinating, by an Nth indexing node, the works at the content layer,.

8. A content network system, comprising:
a content indexing node configured to manage a content address according to a mapping relationship from a content space to a content address space;
a content node configured to write a content or content index into a content indexing node through a content address channel or a direct connection with the content indexing node; and
a content consumer node configured to obtain the content or content index through the content address channel or the direct connection with the content indexing node.

9. An apparatus for publication of contents, comprising:
a numbering unit configured to number a content or content identification to obtain a content index number;
a content address acquisition unit configured to converge the content index number according to a masking or modularization rule to obtain a content address; and
a storage unit configured to store the content index or content to an indexing node where the content address is located.

10. An apparatus for acquisition of contents, comprising:
a numbering unit configured to obtain a content number from an external source or according to a content identification;
a content address acquisition unit configured to obtain a content address from the content number according to a rule; and
a storage unit configured to store the content index or content to an indexing node where the content address is located.
